(19) United States
(12) Patent Application Publication
(10) Pub. No.: US 2024/0076029 A1
(43) Pub. Date: Mar. 7, 2024

(54) Foldable Plane Wing

(71) Applicant: Gökay Pamuk, Münchenstein (CH)

(72) Inventor: Gökay Pamuk, Münchenstein (CH)

(21) Appl. No.: 17/902,822

(22) Filed: Sep. 3, 2022

(51) Int. Cl. B64C 3/56

(52) U.S. Cl. CPC B64C 3/56

(57) ABSTRACT

The present invention relates to an advancement in a foldable aircraft wings assembly for ease in transportation and handling, which consist of two main bodies that that can rotate on the 180 degrees. The wings by rotating the inner body to 90 degrees will enable the plane for vertical takeoff and by rotating the inner and outer body to 180 degrees will fold the wing for parking position.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

This invention relates to aircraft, method of folding aircraft wings, and the improvement of wing folding mechanisms.

### Description of the Related Art

Aircraft comprise lift-generating surfaces to counter the force of gravity and sustain flight. In general, these lifting surfaces must have a sufficiently large planform area to produce adequate lift. Wings are the dominant lifting surface in most aircraft configurations. For a given wing planform area, a wing with a longer span tends to have increased efficiency at the expense of weight and storage footprint. As wing planform area and wing span increase, it becomes harder to store, transport, and otherwise accommodate aircraft on the ground, on a ship, and so forth.

To better and more compactly accommodate aircraft on the ground, wing folding systems have been developed. Many wing folding systems have been developed for naval fighter aircraft because of the unique requirements for stowage with a small footprint aboard an aircraft carrier or other ship. Most of these aircraft use one or more hinges on each side of the wing to fold or rotate a portion of the wing out of the nominal plane of the wing. Usually, the hinges on the left and right sides of the wing are parallel with the centerline of the aircraft for simplicity of engineering and manufacturing. Examples of this conventional approach include U.S. Pat. No. 2,290,850 to Umschweif, U.S. Pat. No. 2,623,713 to Foster, U.S. Pat. No. 2,712,421 to Naumann, U.S. Pat. No. 2,925,233 to Dunn et al., and more recently U.S. Pat. No. 5,381,986 to Smith. Of all the folding systems, parallel hinges are used on the largest number of operational aircraft, including for example the Boeing F/A-18E/F Super Hornet. Although most folding wing aircraft have wing tips that are quite far apart in the folded configuration, some folding-wing aircraft have wing tips that almost touch over the centerline when folded such as the Hawker Sea Hawk.

A few aircraft, such as the Douglas F4D Skyray, have fold lines that are not parallel to the aircraft centerline to avoid folding ailerons. However, for engineering and manufacturing simplicity, the left and right sides of the wing and fold system are symmetric about the centerplane of the aircraft. The wing tips also remain quite far apart in the folded configuration.

A few aircraft, such as the Fairey Gannet, have used a double fold system whereby the wing has two wing fold hinge assemblies per side, allowing the wing to fold twice for additional compactness. This adds additional weight and complexity to the aircraft. Still further, some aircraft, especially those designed to travel on roads as flying cars, incorporate one or more hinges that allow the wing to fold up and back out of the plane of the wing for compactness. Examples of this latter wing folding approach include U.S. Pat. No. 2,572,421 to Abel, U.S. Pat. No. 2,674,422 to Pellarini, U.S. Pat. No. 3,439,890 to Stits, and the Grumman F6F Hellcat and F4F-4 Wildcat.

Some wing stowage systems have been designed for missiles and munitions, which vary wing sweep without folding hinges to achieve compact stowage. Examples of such systems include U.S. Pat. No. 7,732,741 to Whitham, U.S. Pat. No. D461159 to Mirales, et al, and the Small Diameter Bomb. For munitions, it is generally desirable to unfold the wings upon deployment. Some aircraft, such as the Bell/Boeing V-22 Osprey and U.S. Pat. No. 5,337,974 to Rumberger rotate the entire wing in the plane of the wing for compact stowage. Because these wings only rotate in plane, and do not fold out of plane, these are not considered wing folding systems.

Some other aircraft have variable wing sweep, including for example, the Grumman F-14 Tomcat, the General Dynamics F-111 Aardvark, and U.S. Pat. No. 4,569,493 to Burhans, et al. The predominant motivation for the variable sweep is to tailor performance to different flight speeds. As used herein, the term “wing folding system” does not encompass variable wing sweep systems that rotate wings in the plane of the wing during flight.

There are multiple solutions that have been presented in prior art providing advancements in their own domain. However, these solutions are limited and restricted to their conventional architecture, installation system and have considerable shortcomings which adversely affect the convenience with which they can be used. The prior systems have certain limitations including the design of assemblies which make them not suitable for every type of use. Moreover, the ease-of-use ability of these assemblies is also questionable. The current invention proposes an advance methodology of folding wings for ease in transpiration and doesn't lose any aerodynamics of the plane.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention seeks to improve foldable wings setup which provides an enhanced design to perform the designated functionality.

The primary object of this invention is to provide a method and means of folding aircraft wings so that they shall occupy a minimum of space, and to secure the wings so folded to enable the aircraft to move about on the highway or elsewhere.

It is also the objective of invention to provide each side of the wing consisting of two main bodies that that can rotate on the pitch axis 180 degrees. The wing bodies also have a 45-degree separation from top view.

Thus, it is the objective to provide a new and improved form of foldable wing structure which doesn't effects the aerodynamics of the plane.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWING

non-limiting and non-exhaustive embodiments of the present invention are described with reference to the following drawings. The system and method of the present invention will now be described with reference to the accompanying flow chart drawing figure, in which:

FIG. 1 shows the top view of 45-degree separation as per preferred embodiments of the invention.

FIG. 2 shows the wings open in 90 degrees for vertical takeoff as per preferred embodiments of the invention.

FIG. 3 shows the parking position of wings as per preferred embodiments of the invention.

FIG. 4 shows the foldable view of wings as per preferred embodiments of the invention.

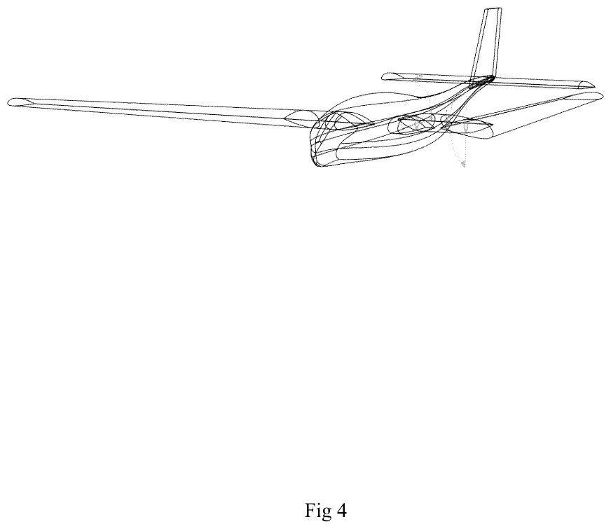

FIG. 5 shows the internal folding view of wings as per preferred embodiments of the invention.

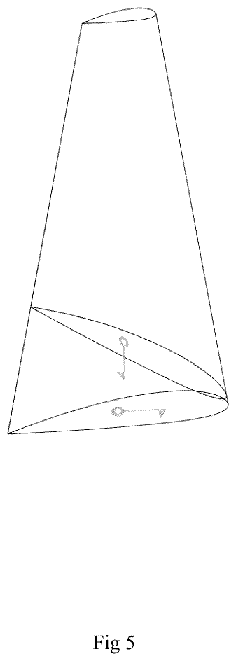

FIG. 6 shows another folding view of wings as per preferred embodiments of the invention.

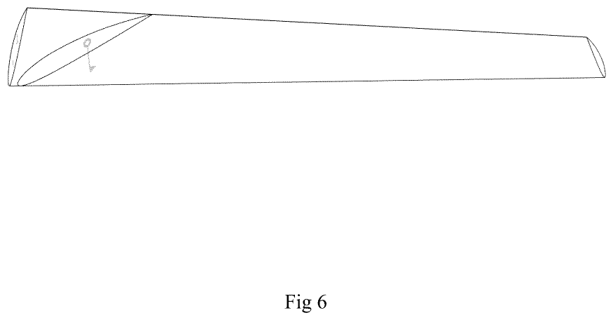

FIG. 7 shows a partial folding view of wings as per preferred embodiments of the invention.

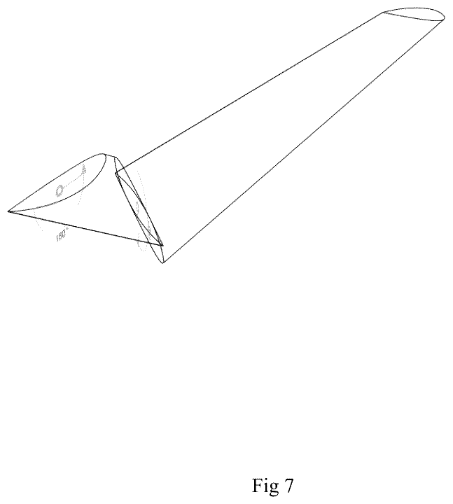

Skilled artisans will appreciate that elements in the figures are illustrated for simplicity and clarity and have not necessarily been drawn to scale. For example, the dimensions of some of the features in the figures may be exaggerated relative to other elements to improve understanding of embodiments of the present invention. The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The current invention as per its preferred embodiments provides a structure of wings for aircrafts which is foldable in nature facilitating ease in transportation.

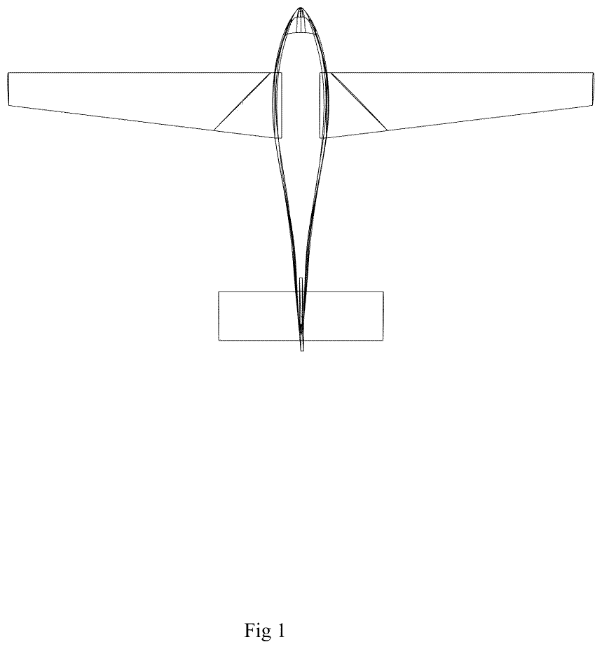

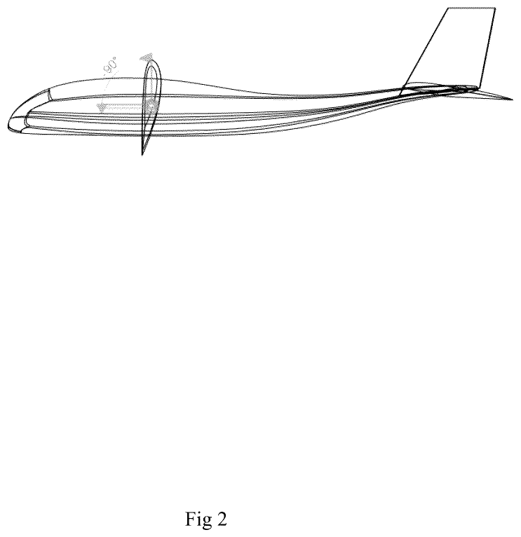

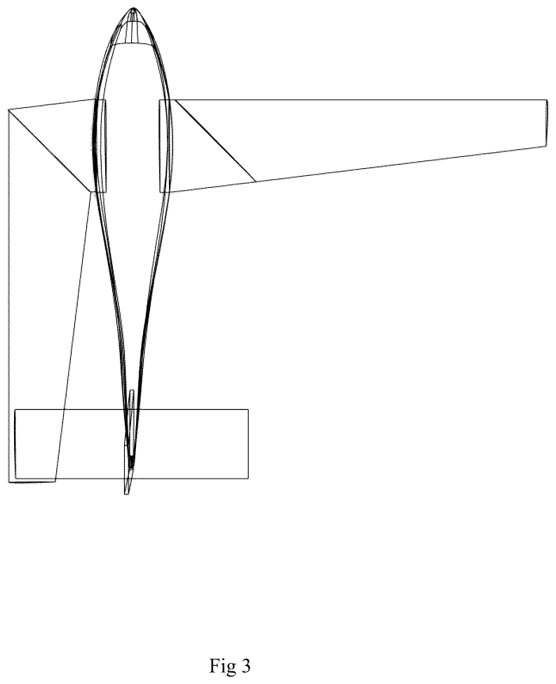

The assembly as per its preferred embodiments comprises of wing which has two main bodies that that can rotate on the pitch axis 180 degrees. The wing bodies have a 45-degree separation from top view (FIG. 1). By rotating the inner body by 90 degrees will enable the plane for vertical takeoff as shown in FIG. 2. As per its further embodiments, by rotating the inner and outer body by 180 degrees will fold the wing for parking position as shown in FIG. 3.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1: A foldable wing assembly comprising:
(a) a wing consisting of two main parts, and,
(b) said body member and outer part, having the ability to rotate on 180 degrees;
The assembly as per claim 1, wherein the wing bodies having a 45-degree separation;
The assembly as per claim 1, wherein by rotating the inner body of wing to 90 degrees will enable the plane for vertical takeoff;
The assembly as per claim 1, wherein by rotating the inner and outer body to 180 degrees will fold the wing for parking position.
